(19) United States
(12) Patent Application Publication
(10) Pub. No.: US 2015/0153201 A1
(43) Pub. Date: Jun. 4, 2015

(54) REPORTING OF METER INDICATION

(71) Applicant: Movelo AB, Stockholm (SE)

(72) Inventors: Peter Händel, Stockholm (SE); Martin Ohlsson, Taby (SE); Jens Ohlsson, Stocksund (SE); Isaac Skog, Stockholm (SE)

(73) Assignee: MOVELO AB, Stockholm (SE)

(21) Appl. No.: 14/370,788

(22) PCT Filed: Jan. 9, 2013
(86) PCT No.: PCT/SE2013/050009

§ 371 Date: Jul. 7, 2014

(30) Foreign Application Priority Data
Jan. 9, 2012 (SE) 1230004-2

(51) Int. Cl. G01D 4/00; G07C 5/00; G01D 9/00

(52) U.S. Cl. CPC G01D 4/00; G01D 9/00; G07C 5/00

(57) ABSTRACT

Device (100) for reporting meter indication (160) for a movable machine or vehicle (150), comprising means for reading of one or more meter indications (210) for the movable machine or vehicle (150) via optical imaging with a camera, means for determination of an identity (220) of the movable machine or vehicle (150), means for determination of an identity (230) of a reporter (120), means for determination of a time (250) for the reading of one or more meter indications (210), means for determination of a position (240) of the movable machine or vehicle (150) at this time (250), means for checking of the identity (220) of the movable machine or vehicle (150) and the identity (230) of the reporter (120) against a list of approved identities and means for transfer of one or more meter indications (210), the identity (220) of the movable machine or vehicle (150), the identity (230) of the reporter (120), the time (250) and the position (240) to a central server (60).

### TECHNICAL FIELD

The present invention relates to electronic devices such as mobile phones in general and more particularly to methods and devices for reporting meter indication for movable machines and vehicles.

### BACKGROUND

For entrepreneurs with their own machine or vehicle fleet it is important to regularly maintain these to ensure operational reliability and reduce costs connected to machine or vehicle fleet, for example service, operational or insurance costs. Despite the entry of information technology in our daily life in general, a majority of machines and vehicles are in the current situation only equipped with simpler mechanical or electronic displays which indicate a meter indication—for example the hour meter on a movable diesel generator for power supply, or the odometer in a vehicle such as a private car, truck, or bus. Service, operational or insurance costs are often directly proportional to the usage, which is indicated by the meter indication. By regular and reliable central access to meter indication it is possible for example to schedule service according to a service plan, and over- or under-insurance of the equipment can be avoided.

Reading of these meters is usually done manually and note of operational status is reported orally or in writing to for the reporter central location for monitoring of the machine or vehicle fleet. Reporting in writing is normally done via paper and pen, email or SMS, or by direct manual reporting into a database. When reporting meter indication manually, there is however a risk of reading errors, writing errors or other errors due to human factors. In addition, it takes time and therefore one is perhaps not so inclined to perform the reporting as often as it may be desired.

To replace a manual reporting of meter indication with a completely automatic reporting is often economically justifiable just in special cases, for example at a very large number of units or by official decisions. Such an example is the replacement of manual reading of electricity meters in residences with automated remote reading, which is a direct result of that in Sweden all electricity customers shall be billed by actual consumption as from year 2009. In connection with this directive a large part of manual meters were replaced by automatic meters which deliver digital information about meter indication via wireless or wired communication. At present, this is however hardly a realistic alternative for reading in a machine or vehicle fleet, since it is associated with large costs.

Apart from entrepreneurs with their own machine fleets haulage contractors, bus companies, or taxi companies are examples of organisations where a large number of drivers drive a large number of vehicles. It is naturally desirable for such organisations to use aids for increased operational reliability, efficiency improvement and cost reductions. Other examples are organisations whose customers have vehicles or vehicle fleets, for example petrol companies, insurance companies, car sales and spare parts sales companies and car repair shops. It is naturally desirable for such organisations to easily via the customer collect and process information that may facilitate the customer's dialog with the organisation.

Since it is not always suitable with neither manual reading and reporting, nor completely automatic reporting of information such as meter indication(s) of vehicles, there is thus a need for a simple and reliable way to centrally report meter indication for movable machines or vehicles.

### SUMMARY

An object of the present invention is to provide an apparatus and a method for reporting one or more meter indications for a movable machine or vehicle to a central server.

This object is met by the present invention which is defined by the enclosed patent claims. An aspect relates to a method for reporting meter indication for a movable machine or vehicle. The method comprises reading of one or more meter indications for the movable machine or vehicle via optical imaging with a camera. The method further comprises determination of an identity of the movable machine or vehicle, determination of an identity of a reporter, determination of a time for the reading of one or more meter indications, determination of the position of the movable machine or vehicle at the time for the reading of one or more meter indications. The method also comprises checking of the identity of the movable machine or vehicle and the identity of the reporter against a list of approved identities. The method further comprises transfer of one or more meter indications for the movable machine or vehicle, the identity of the movable machine or vehicle, the identity of the reporter, the time for the reading of one or more meter indications and the position of the movable machine or vehicle at the time for the reading of one or more meter indications to a central server.

A further aspect relates to a device for reporting meter indication for a movable machine or vehicle. The device comprises means for reading of one or more meter indications for the movable machine or vehicle via optical imaging with a camera. The device further comprises means for determination of an identity of the movable machine or vehicle, means for determination of an identity of a reporter, means for determination of a time for the reading of one or more meter indications, means for determination of the position of the movable machine or vehicle at the time of the reading of one or more meter indications. The device also comprises means for checking of the identity of the movable machine or vehicle and the identity of the reporter against a list of approved identities. The device further comprises means for transfer of one or more meter indications for the movable machine or vehicle, the identity of the movable machine or vehicle, the identity of the reporter, the time for the reading of one or more meter indications and the position of the movable machine or vehicle at the time for the reading of one or more meter indications.

An advantage of the present invention is that it enables reading and central storing of meter indication from mechanical or electronic meter displays, while at the same time the identity of the device where the meter in installed and the identity of the reporter can be validated. A further advantage is that parameters such as current time and position of the device where the meter is installed also can be transferred to the central server.

### BRIEF DESCRIPTION OF THE DRAWINGS

The invention will be described in more detail in the following with reference to the accompanying drawings, which illustrate examples of selected embodiments, where:

FIG. 1 shows an example of a device in accordance with the present invention;

FIG. 2 shows an example of an information packet in accordance with the present invention; and

FIG. 3 shows an example of a flow chart for an embodiment of a method in accordance with the present invention.

### DETAILED DESCRIPTION

As mentioned in the background there is a need for an alternative way for central reporting of meter indication for movable machines or vehicles. An alternative available manner to modify e.g. an existing electrical meter from manual reading to automated remote reading is to install on said existing meter small smart reading cameras, with one reading unit mounted per meter. Digital reading cameras which automatically read the meter, pass on the image via the mobile network or Internet, are offered for instance by the product MeterCam from the company Alteros AB. This is an example of a solution that works in environments without great external mechanical influence such as remote reading of electricity, gas, water and district heating consumption, but is not a realistic alternative for reading in a machine or vehicle fleet. It is also an example of a solution that requires a fixedly mounted digital reading camera for each meter that should be remotely read. This is furthermore an example of a solution that does not provide any information about where the machine or vehicle is located.

The introduction of so-called smartphones such as iPhone and Android-based phones such as HTC Desire has increased the availability of the information technology—the functionality of the mobile phone has multiplied from being a device for voice calls to a device with a versatile field of application. Other equipment with overlapping functionality comprises for example palm-pilots, tablets such as iPad and Android-based tablets such as Samsung Galaxy Tab P1000, notebooks, PC laptops or other general portable computer products where the functionality for the user may be adapted by downloading of computer programs from electronic market places such as App Store or Android Market or computer readable media such as CD, DVD, USB-memory, hard drive, etc. Personal electronics as exemplified above will for simplicity be given the collective name mobile phone in the following.

Modern mobile phones have after downloading of suitable functionality implemented through software modules support for functions such as imaging via photography, data transfer through wireless connection to central server, and marking with time and place via GPS or other satellite system or via positioning in the mobile phone networks, or combinations of the two methods. Several satellite navigation systems exist such as GPS (United States NAVSTAR Global Positioning System), GLONASS (Russian Global Navigation Satellite System), Galileo (Europe), COMPASS (China)—which are gathered under the collective name GNSS (Global Navigation Satellite System). An example of GNSS with support from local positioning with the aid of the mobile phone systems is assisted GPS (A-GPS). In particular GPS of the different GNSS-systems has had a major impact and GPS receivers are nowadays found in a majority of mobile phones, and in a great majority they have support for A-GPS.

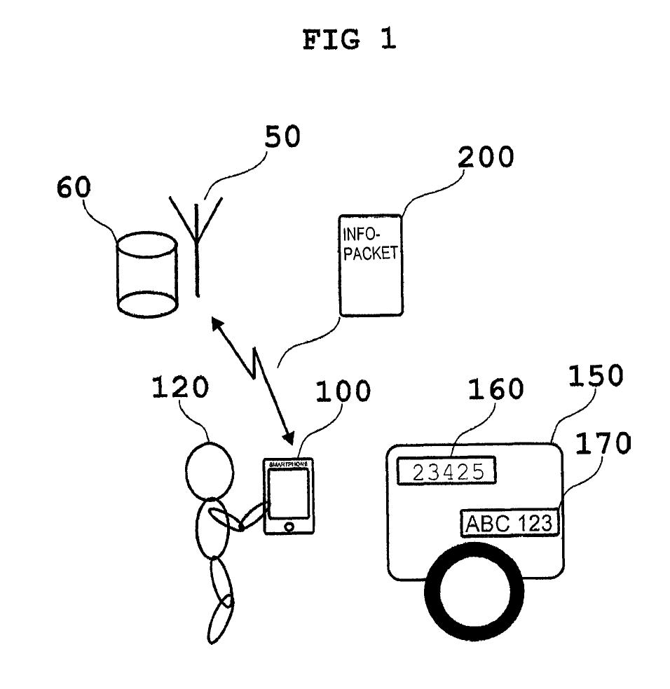

The present invention fulfils the above described need by providing a device for reporting meter indication for a movable machine or vehicle. FIG. 1 shows an embodiment of the invention that comprises means for reading of one or more meter indications for the movable machine or vehicle 150 via optical imaging with a camera. The device further comprises means for determination of an identity of the movable machine or vehicle 150, means for determination of an identity of a reporter 120, means for determination of a time for the reading of one or more meter indications, means for determination of a position of the movable machine or vehicle 150 at the time for the reading of one or more meter indications. The device also comprises means for checking of the identity of the movable machine or vehicle 150 and the identity of the reporter 120 against a list of approved identities. The device further comprises means for transfer of one or more meter indications for the movable machine or vehicle 150, the identity of the movable machine or vehicle 150, the identity of the reporter 120, the time for the reading of one or more meter indications and the position of the movable machine or vehicle at this time. The transfer is done in a preferred embodiment to a central server 60. In a particular embodiment the determination of the identity of the movable machine or vehicle 150 is done via optical imaging with a camera.

The present invention thus comprises functionality that in one embodiment may be implemented in a modern mobile phone to replace a manual reading and reporting of meter indication with a reading and central storing of meter indication from for example mechanical or electronic displays, by imaging with a camera.

In order to be able to ease up on the requirement for unique reading equipment for each meter panel, it is also important to be able to determine the identities of both the reporter and the movable machine or vehicle. Since the person reporting meter indication often reads the meter indication on several objects (i.e. movable machines or vehicles) it is important that the identity of the object is indicated in the report, for example by inventory number, serial number, registration number, or other unique identity marking. Since the identity of the reporter may differ from time to time, it is also important that his/her identity is indicated, for example by name, employment number, personal identity number, customer number, or other unique identity marking. To ensure that the reports are trustworthy a check against a list of approved identities of object or reporter can be used—where an approved measurement report requires that reported identities are present on said list of approved identities.

Apart from current meter indication, the identity of the object and the identity of the reporter, other parameters are often of interest. Especially for movable machines and vehicles current position at specific times is of interest, for example to efficiently manage operation and maintenance. These parameters of interest may further comprise other operational conditions such as temperature, weather conditions, load or other information about the operational history

The embodiment shown in FIG. 1 comprises a mobile phone 100 with built-in camera and GPS, and support for mobile data traffic. The reporter 120 uses in one embodiment the camera in the mobile phone 100 to photograph the meter indication 160 of the movable machine or vehicle 150. In a particular embodiment the reporter 120 uses the camera in the mobile phone 100 also to photograph the license plate 170 of the movable machine or vehicle 150 to determine the identity of the movable machine or vehicle 150. In one embodiment an information packet 200 is formed from the retrieved information, see further below. After that, the information packet 200 is in one embodiment sent by wireless transfer 50 via for example 2G, 3G, 4G, or WLAN from the mobile phone 100 to a central server 60 where it is stored.

Mobile phone 100 may in one embodiment also physically consist of separate units, for example separate data modem, GPS-receiver and camera, which in one embodiment are used separately and in another embodiment are wirelessly 15 connected to each other through suitable protocol such as IR-technique (infrared), Bluetooth, Wireless USB, Cypress WirelessUSB, ZigBee, WLAN or other available radio standard.

The information forming the information packet 200 may in different embodiments naturally be sent in separate parts or individual packets to the central server 60; depending on type of wireless network or other system aspects.

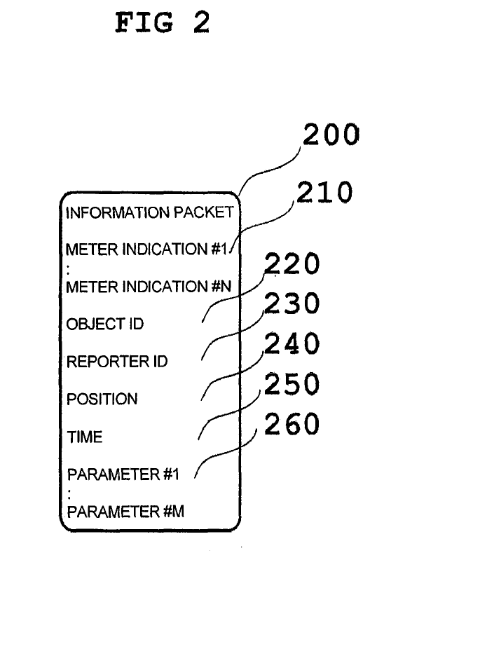

A machine or a vehicle may in one embodiment be equipped with more than one meter that needs to be read. FIG. 2 shows an example of an embodiment of the structure of a basic information packet 200, consisting of N number of read meter indications 210, the object identity 220, the reporter identity 230, the time 250 for the reading, the position 240 at this time, and M number of other retrieved parameters of interest 260.

Meter indication 210 may comprise different types of quantities. In one embodiment meter indication 210 refers to at least one of the quantities time and distance.

In a particularly preferred embodiment the meter indication 210 is read optically by the built-in camera in the mobile phone 100. Optical reading and recognition of numbers and text is well-known technique and may be done with available methods, so-called OCR (Optical Character Recognition). The meter indication 210 may in another embodiment be entered manually by the reporter.

Also the identity 220 of the movable machine or vehicle may in one embodiment be entered manually by the reporter, or as in a particularly preferred embodiment be read optically via the built-in camera in the mobile phone 100, by e.g. photography of license plate, serial number or other unique identifier of the movable machine or vehicle.

The identity 230 of the reporter 120 may in one embodiment be linked to the identity of the mobile phone 100, for example in the cases the reporters have access to individual mobile phones. In this embodiment the identity of the reporter 120 may be linked to the identity of the mobile phone 100, which in turn may be determined for example based on phone number, IMEI, MAC-address or other information linked to the mobile phone 100.

In the case the identity 230 of the reporter 120 cannot be linked to the identity of the mobile phone 100, the identity 230 of the reporter may in one embodiment be linked e.g. to entering of name, PIN code, voice sequence or image. The reporter shall then validate his/her personal identity against a stored identity in order to be able to use the stored identity as the identity 230 of the reporter. The stored identity may in one embodiment be stored in a permanent memory circuit or other memory device in the mobile phone. Validation of the personal identity of the reporter against the stored identity may in an embodiment be done e.g. by entering of name or PIN code that is linked to the stored identity. The validation may in another embodiment be done for example via voice signature, photograph, or biometric reading such as fingerprint. In the latter case the validation may be done with available technique; for example voice recognition that may be used for e.g. voice control, face recognition for e.g. automatic sorting of digital photographs, or fingerprint reading for e.g. entry access.

The position 240 may in one embodiment be determined by manual entering by the reporter, and in another embodiment be determined mechanically via satellite based positioning systems and/or mobile phone based positioning systems, for example via a built-in GPS-receiver in the mobile phone 100. Information about current position is in an embodiment available in the mobile phone 100 for example via positioning in the mobile network, or other radio network such as WLAN.

The time 250 for reading of meter indication is in one embodiment determined by aid of for example system clock, GPS clock or other available clock.

Other parameters of interest 260 may in one embodiment be indicated manually and in another embodiment be retrieved automatically, for example from available sensors in the mobile phone 100 such as for example thermometer, accelerometer, gyroscope, magnetometer, camera, microphone; or via data services such as for example weather information, traffic information.

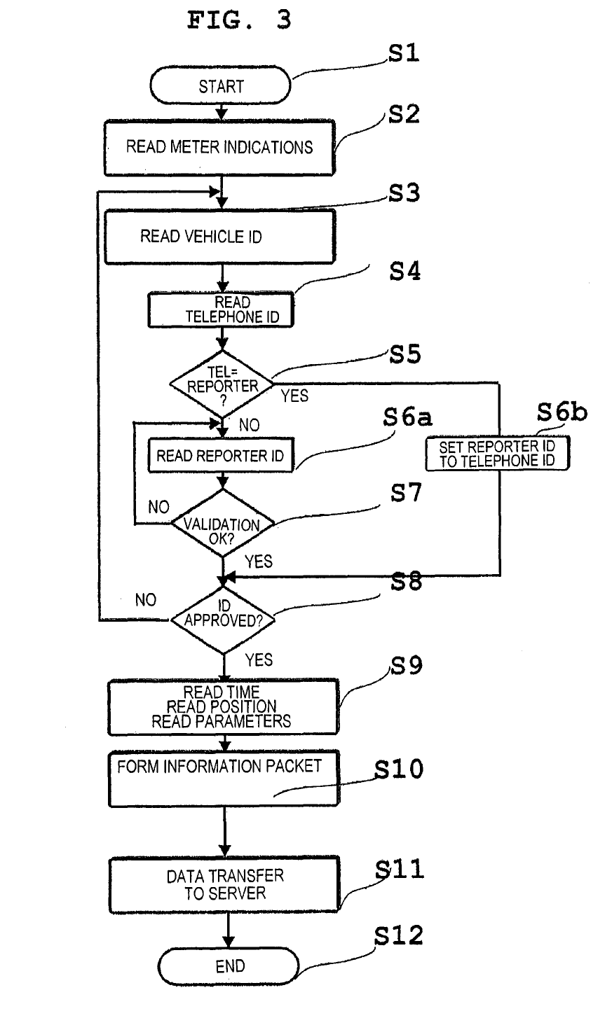

FIG. 3 shows a flow chart for an embodiment of a method for reporting meter indication for a movable machine or vehicle. The method comprises the step S2 to read one or more meter indications for the movable machine or vehicle via optical imaging with a camera. The method further comprises the step S3 to determine an identity of the movable machine or vehicle, the steps S4, S6b; S6a, S7 to determine an identity of a reporter, the step S9 to determine a time for the reading S2 of one or more meter indications, the step S9 to determine a position of the movable machine or vehicle at the time for the reading S2 of one or more meter indications. The method also comprises the step S8 to check the identity of the movable machine or vehicle and the identity of the reporter against a list of approved identities. The method further comprises the step S11 to transfer one or more meter indications for the movable machine or vehicle, the identity of the movable machine or vehicle, the identity of the reporter, the time for the reading S2 of one or more meter indications and the position of the movable machine or vehicle at this time to a central server.

In a particular embodiment the step S3 to determine the identity of the movable machine or vehicle is done via optical imaging with a camera.

This method forms in one embodiment an information packet 200 as exemplified in FIG. 2, which is sent to a central server. In an embodiment the transfer in step S11 is done wirelessly via radio.

The step S1 in FIG. 3 indicates the starting state for the method and may in one embodiment for example be initiated when the reporter activates the application for reporting of meter indication on his/her mobile phone.

In the step S2 one or more meter indications of the movable machine or vehicle is/are read. In a particularly preferred embodiment the reading is done via optical imaging with a camera. Optical reading and recognition of numbers and text may e.g. be done through OCR-technique (see above).

In the step S3 the identity of the movable machine or vehicle is determined. In one embodiment the determination is done by manual entering by the reporter. In another embodiment the determination is done via optical imaging with a camera by e.g. photography of license plate, serial number or other unique identifier the movable machine or vehicle.

In the step S4 the identity of the mobile phone is determined for example based on phone number, IMEI, MAC-address or other information linked to the mobile phone.

The step S5 tests in one embodiment if determination of the identity of the reporter should be based on the identity of the mobile phone, or if the personal identity of the reporter should be used. In the first case the identity of the reporter is set to the identity of the mobile phone in step S6b, and the method then proceeds to the step S8. So, in this case determination of the identity of the reporter is done by the steps S4 and S6b.

If determination of the identity of the reporter instead should be based on the personal identity of the reporter the method proceeds to the step S6a. In the step S6a a stored identity of the reporter is read in an embodiment. The stored identity may in an embodiment be stored in a permanent memory circuit or other memory device in the mobile phone. In one embodiment the reporter shall validate his/her personal identity against the stored identity in order to be able to use the stored identity as the identity of the reporter. This validation may in one embodiment be done e.g. by entering of name or a PIN code which is linked to the stored identity. Validation of the personal identity of the reporter against the stored identity may in another embodiment for example be done via voice signature, photograph, or biometric reading such as e.g. fingerprint. In the latter case the validation may be done with available technique; for example voice recognition that may be used for e.g. voice control, face recognition for e.g. automatic sorting of digital photographs, or fingerprint reading for e.g. entry access. Test that the validation is successful is done in an embodiment in the step S7. So, in this case determination of the identity of the reporter is done by the steps S6a and S7.

The step S8 checks in an embodiment if the identity of the reporter and the identity of the movable machine or vehicle are approved by comparing with approved identities on a list. That the identities are approved also comprises the case that all determined identities within one of the groups of identities are approved and also that all determined identities are approved. This means that it does not matter which the determined identity is but that all are approved. So, no check of the determined identity is done. This may apply for the identity of the vehicle or the identity of the reporter or both.

The list of approved identities may in one embodiment be administered by the database on the central server and in case of updating be sent down to the mobile phone. In another embodiment a request may be done directly from the mobile phone against the central server. The first manner is preferable when there is a risk of bad coverage for the wireless communication. The test in step S8 may thus in an embodiment be performed in the mobile phone 100 and in another embodiment by transfer of said information regarding identities to an external server, for example via 2G, 3G, 4G or WLAN or other standard for wireless communication.

The step S8 to check the identity of the movable machine or vehicle may in an embodiment be done by the identity being checked against a central vehicle register, such as the vehicle register from the Swedish Transport Administration if the vehicle is registered in Sweden, or other vehicle register managed by an authority.

If the outcome of the test in the step S8 is positive the time for the reading of one or more meter indications, the position of the movable machine or vehicle at this time and any other parameters of interest are determined in the step S9 in one embodiment. The determination of the position of the movable machine or vehicle may in one embodiment be done be via satellite based positioning systems and/or mobile phone based positioning systems, for example via a built-in GPS-receiver in the mobile phone. The time for reading of meter indication is determined in one embodiment by aid of for example system clock, GPS clock or other available clock.

If the outcome of the test in the step S8 is negative the method returns to the step S3 in an embodiment.

The step S10 forms in an embodiment an information packet by bringing together information retrieved in the steps S2, S3, S4 or S6a, and S9.

The step S11 transfers in an embodiment the information packet to a central server. In an embodiment this transfer is done via wireless technique.

The step S12 finishes the method.

The steps in the method shown in FIG. 3 must not necessarily be done in the order described above, or as illustrated in FIG. 3. For example, the determination S3 of the identity of the movable machine or vehicle may be done before the reading S2 of meter indication, and/or the determination of the identity of the reporter may occur before both of these steps, or between them. The determination S9 of time, position and other parameters may alternatively occur directly after the starting state S1 and before all other steps, or between some of the other steps. Forming S10 of the information packet and transfer S11 of the information packet must however naturally be the two last steps before finishing S12 of the method.

The present invention may in an embodiment be implemented as a microprocessor, a digital signal processor (DSP), or a combination with corresponding software. In an embodiment a laptop with connected GPS, camera and wireless modem may be used. The method may then be implemented as a computer program which is installed in the computer through computer readable media such as CD, DVD, USB memory, hard drive etc. The steps of the method are then performed by program elements in this program. Another possible implementation is to use programmable logic in FPGA (Field Programmable Gate Arrays) or ASIC (Application Specific Integrated Circuit).

The above described embodiments should be regarded as examples of the present invention. The skilled person understands that different modifications, combinations and changes of the described embodiments may be done without diverting from the scope of the present invention. The scope of the present invention is however defined by the enclosed patent claims.

1. A method for reporting meter indication for a movable machine or vehicle, the method comprising:
reading of at least one meter indication for the movable machine or vehicle via optical imaging with a camera;
determining of an identity of the movable machine or vehicle;
determining of an identity of a reporter;
determining of a time for the reading of the at least one meter indication;
determining of a position of the movable machine or vehicle at the time for the reading of the at least one meter indication;
checking of the identity of the movable machine or vehicle and the identity of the reporter against a list of approved identities; and
transferring of the at least one meter indication for the movable machine or vehicle, the identity of the movable machine or vehicle, the identity of the reporter, the time for the reading of the at least one meter indication, and the position of the movable machine or vehicle at the time for the reading of the at least one meter indication to a central server.

2. The method according to claim 1, wherein the determining of the identity of the movable machine or vehicle is done via optical imaging with a camera.

3. The method according to claim 1, wherein the transferring is done wirelessly via radio.

4. The method according to any preceding claim 1, wherein the at least one meter indication for the movable machine or vehicle refers to at least one of the following quantities:
time; and
distance.

5. The method according to claim 1, wherein the checking of the identity of the movable machine or vehicle is done by checking against a central vehicle register.

6. The method according to claim 1, wherein the determining of the position of the movable machine or vehicle is done by at least one of the following:
satellite based positioning systems; and
mobile phone based positioning systems.

7. A device for reporting meter indication for a movable machine or vehicle, the device comprising:
means for reading of at least one meter indication for the movable machine or vehicle via optical imaging with a camera;
means for determining of an identity of the movable machine or vehicle;
means for determining of an identity of a reporter;
means for determining of a time for the reading of the at least one meter indication;
means for determining of a position of the movable machine or vehicle at the time for the reading of the at least one meter indication;
means for checking of the identity of the movable machine or vehicle and the identity of the reporter against a list of approved identities; and
means for transferring of said the at least one meter indication for the movable machine or vehicle, the identity of the movable machine or vehicle, the identity of the reporter, the time for the reading of the at least one meter indication, and the position of the movable machine or vehicle at the time for the reading of the at least one meter indication.

8. The device according to claim 7, wherein the means for determining of the identity of the movable machine or vehicle comprises a camera.
